(19) United States
(12) Patent Application Publication
(10) Pub. No.: US 2006/0179668 A1
(43) Pub. Date: Aug. 17, 2006

(54) Device for adjusting foot plate of a jigsaw

(76) Inventor: Shuming Wu, Nanjing City (CN)

Correspondence Address: WALLENSTEIN & WAGNER, LTD., 311 SOUTH WACKER DRIVE, 53RD FLOOR, CHICAGO, IL, 60606, US

(21) Appl. No.: 11/345,466

(22) Filed: Feb. 1, 2006

(30) Foreign Application Priority Data
Feb. 1, 2005 (CN) 200520068776.3

(51) Int. Cl. B23D 49/16

(52) U.S. Cl. 30/392

(57) ABSTRACT

A device for adjusting a foot plate of a saw. The device includes a locking member with a fastener connected therewith for fastening the foot plate to a housing of a saw. A rotatable sleeve is connected to the locking member for rotating the locking member. A rotatable actuator assembly is pivotally connected to the rotatable sleeve for turning the rotatable sleeve. The rotatable sleeve and locking member can be engaged or disengaged with each other by effect of a biasing member or spring therebetween. Therefore, when the rotatable sleeve and locking member are engaged with each other, the rotatable actuator assembly can be turned to rotate the rotatable sleeve, and the bolt which is fixed to the locking member is rotated consequently to adjust the tightness or looseness between the foot plate and housing of a saw. When the rotatable sleeve and locking member are disengaged from each other, the rotatable actuator assembly and the rotatable sleeve can be freely rotated to a position where they can be manually pressed into a recess or space within the foot plate and stored therein such that cutting will not be obstructed. With such an adjusting device, the position of the foot plate of a jigsaw can be easily adjusted in respect to the housing with no need of any other tools.

### CROSS-REFERENCE TO RELATED APPLICATIONS

This application claims priority to Chinese Application No. 200520068776.3, filed on Feb. 1, 2005.

### FEDERALLY SPONSORED RESEARCH OR DEVELOPMENT

None

### TECHNICAL FIELD

The invention relates to an adjusting device for fastening or loosing a foot plate of a jigsaw, thereby to adjust inclination right and left or position fore and aft of the foot plate.

### BACKGROUND OF THE INVENTION

The foot plate of a jigsaw in the prior art includes an upward dome portion with an elongated through slot at its top. The surface of a housing of a jigsaw, which is matched with the foot plate, is provided with a recess corresponding to the dome. A foot plate can be secured firmly to the housing of a jigsaw by inserting a bolt through the elongated slot of the dome portion of the foot plate and turning the bolt into a threaded member such as a nut fixed to the housing. When it is necessary to adjust inclination right and left or position fore and aft of the foot plate, the bolt is loosed and then the foot plate is adjusted to a desired position and finally the bolt is refastened. In prior jigsaws, to fasten and/or unfasten the bolt one would typically need to use a tool such as a bolt driver or spanner, which is inconvenient.

A locking device for a foot plate of a jigsaw is disclosed in U.S. Pat. No. 5,617,638, wherein the bolt is attached fixedly with a small spanner for fastening or unfastening the bolt, thereby tightening or loosening the foot plate. A drawback of the locking device of this type, however, is that the small spanner cannot be turned up to a complete turn because of being limited by the housing of the jigsaw. Accordingly, the bolt's longitudinal moving distance is a bit too short, so that the adjustment range of the foot plate is limited. Moreover, because the small spanner is inconveniently located under the tail of a housing, it is difficult to operate.

There have been prior attempts to make a jigsaw with a self-contained tool for adjusting the connection between the foot plate and the housing of the saw. In addition to the solution of the above-mentioned patent, some prior jigsaws have included an adjustable fastening mechanism on the bottom of the jigsaw. However, because the lower part of a foot plate is typically elongated with very small lateral dimensions, there is not enough space for such a mechanism to function well. Further, a user cannot remove the fastening mechanism from the space below the foot plate (e.g., a recess in the foot plate) and manually press the mechanism into the space after adjustment, because often times, after the fastening mechanism is rotated to tighten the fastener, the fastening mechanism cannot be realigned with the elongated slot.

The present invention solves these and other drawbacks of prior jigsaws adjusting foot plates. A full discussion of the features and advantages of the present invention is deferred to the following detailed description, which proceeds with reference to the accompanying drawings.

### SUMMARY OF THE INVENTION

One object of the present invention is to provide a device for adjusting a foot plate of a jigsaw. With the adjusting device of the present invention, the foot plate of a jigsaw can be easily fastened or adjusted without the need for any other tools.

To achieve the above object, a device for adjusting a foot plate of a jigsaw disclosed in the invention comprises a locking member having a first end and a second end. The first end of the locking member is connected to a fastening member connected to (and typically located inside) the saw housing. The second end of the locking member is connected to a rotatable actuating assembly, which when actuated can be used to fasten the foot plate to the housing and/or adjust the inclination of the foot plate with respect to the housing of the saw.

The rotatable actuating assembly includes a rotatable sleeve for rotating (i.e., tightening or loosening) the locking member with respect to the fastening member. The rotatable sleeve and the locking member include a pair of engagement portions which are engageable with each other. A biasing member or spring is located between the rotatable sleeve and the locking member for bringing about the engagement or disengagement therebetween. The rotatable actuating assembly also includes a foldable, operating rod and handle that are connected to the rotatable sleeve.

In operation, the rotatable actuating assembly is aligned with and slidably folded into a recess or opening in the foot plate. In this configuration, cutting of a workpiece is not obstructed. In order to adjust or loosen the foot plate from the housing of the saw, the rotatable actuating assembly is drawn out of the recess or opening in the foot plate (by slidably unfolding the handle and operating rod from the rotatable sleeve). In a first operating position, the rotatable sleeve and locking member are engaged with each other and the rotatable actuator assembly can be turned to rotate the turnable sleeve. As a result, the locking member which has a fastener (e.g., a bolt) connected to the fastening member is loosened. In this manner, one can fasten/unfasten the foot plate from the housing of a jigsaw and/or loosen and adjust the angle of the foot plate with respect to the housing. In a second operating position, the turnable sleeve and locking member are disengaged from each other. In this operating position, the rotatable actuator assembly and the turnable sleeve can be freely rotated without turning the locking member. Accordingly, the rotating actuator assembly and rotatable sleeve can be rotated to a position where they can be manually inserted (e.g., slid and folded) into the space within the foot plate and stored in the recessed space such that cutting will not be obstructed. With such an adjusting device, the position of the foot plate of a saw can be easily adjusted in respect to the housing with no need of any other tools.

Other features and advantages of the invention will be apparent from the following specification taken in conjunction with the following drawings.

### BRIEF DESCRIPTION OF THE DRAWINGS

An exemplary embodiment of the invention will be described below in detail in reference with the accompanying drawings, wherein,

FIG. 1 is a front elevation of a jigsaw with some portions omitted and a portion longitudinally sectioned for showing an adjusting device of its foot plate according to the present invention;

FIG. 2 is a lateral section of the foot plate and its adjusting device of the jigsaw shown in FIG. 1;

FIG. 3 is an exploded perspective view of the foot plate and adjusting device of the jigsaw shown in FIG. 1;

FIG. 4 is a perspective view showing one position of a rotatable actuator assembly of the foot plate adjusting device; and

FIG. 5 is a perspective view showing another position of the rotatable actuator assembly of the foot plate adjusting device.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

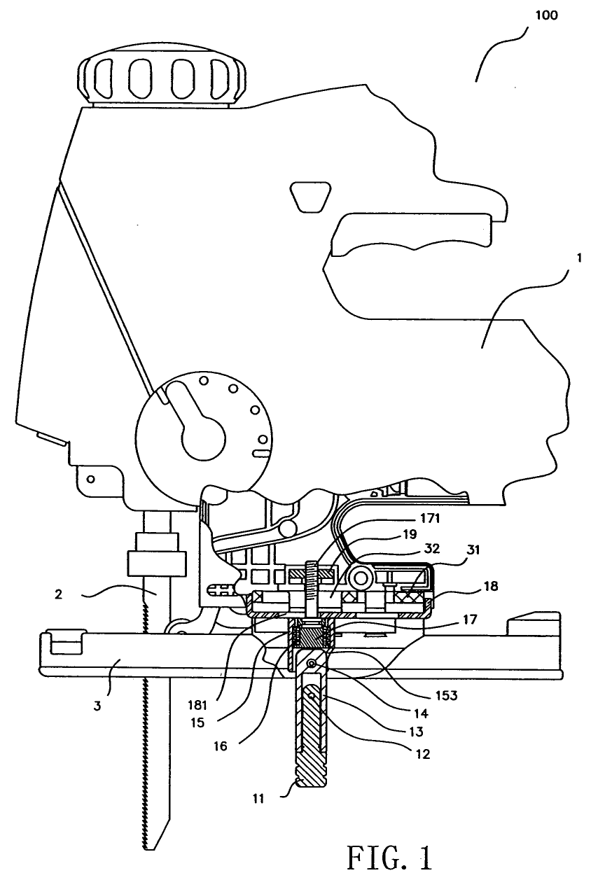

As shown in FIG. 1, a saw (e.g., a jigsaw) 100 comprises a housing 1, a saw blade 2, a foot plate 3, a drive system (not shown) contained in the housing 1 for bringing reciprocating movement of the saw blade 2. An object can be cut by aligning it underneath the foot plate 3 and bringing the object into contact with the reciprocating movement of the saw blade 2. The jigsaw 100 further includes a foot plate adjusting device 10 for fastening and/or adjusting the foot plate 3. Thus, the foot plate 3 is adjustable to form a desired angle between a substantially horizontal reference plane, which is substantially perpendicular to the saw blade 2 so that cuts of various angles can be accomplished in the workpiece.

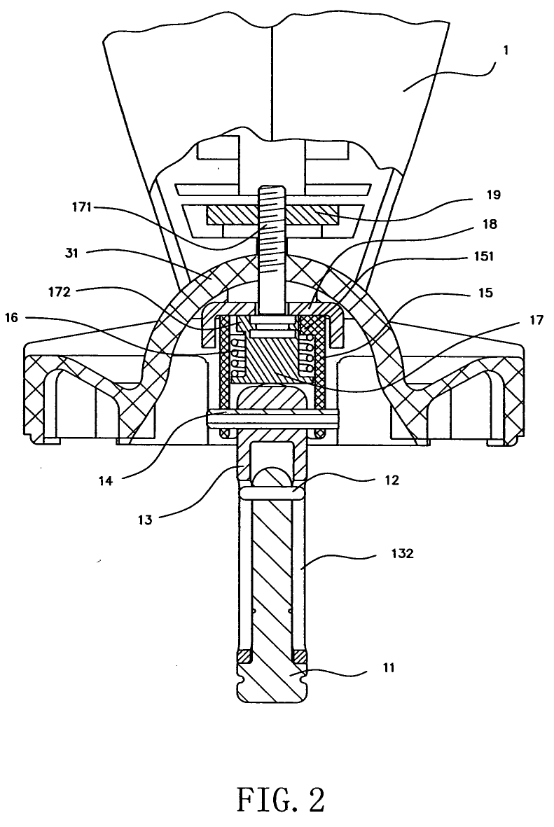

Now, referring to FIGS. 1 to 3, the configuration and components of a preferred embodiment of the present invention will be described in detail. As seen clearly in FIGS. 1 and 2, a fastening plate 19 (e.g., a conventional nut) is fixed in the housing 1. The fastening plate 19 comprises a threaded hole 191 at its central place for receiving a fastener 171 (e.g., a conventional threaded bolt) of foot plate 3. In this manner, the foot plate 3 is connected to the housing 1 of the saw. The foot plate 3 includes a domed or curvilinear portion 31 which cooperates with the foot plate adjusting device 10.

The foot plate adjusting device 10 includes a locking member 17 which has a fastener 171 (e.g., a threaded bolt) secured to one end and a gasket 18. The gasket 18 cooperates with the surface of the domed or curvilinear portion 31 of the foot plate 3 to secure the foot plate 3 to the housing 1 of the saw. The fastener 171 is inserted through a hole 181 in the gasket 18 and an elongated slot 32 in the dome portion 31. The elongated slot 32 allows for adjustment of the foot plate 3 in a fore and aft direction with respect to the saw blade 2. The fastener 171 is consequently connected to the fastening plate 19 in the housing 1. In a preferred embodiment wherein the fastener 171 comprises a threaded bolt, by turning the bolt 171, a user tightens or can loosen the dome or curvilinear portion 31 of the foot plate 3 with relationship to the housing 1. Accordingly, due to the curvilinear surface of the dome portion 31, the foot plate 3 may be adjusted and fastened in an inclined manner with respect to the housing 1. That is, the foot plate 3 may be tilted such that one side edge of the foot plate 3 is inclined relative to the other side edge of the foot plate 3.

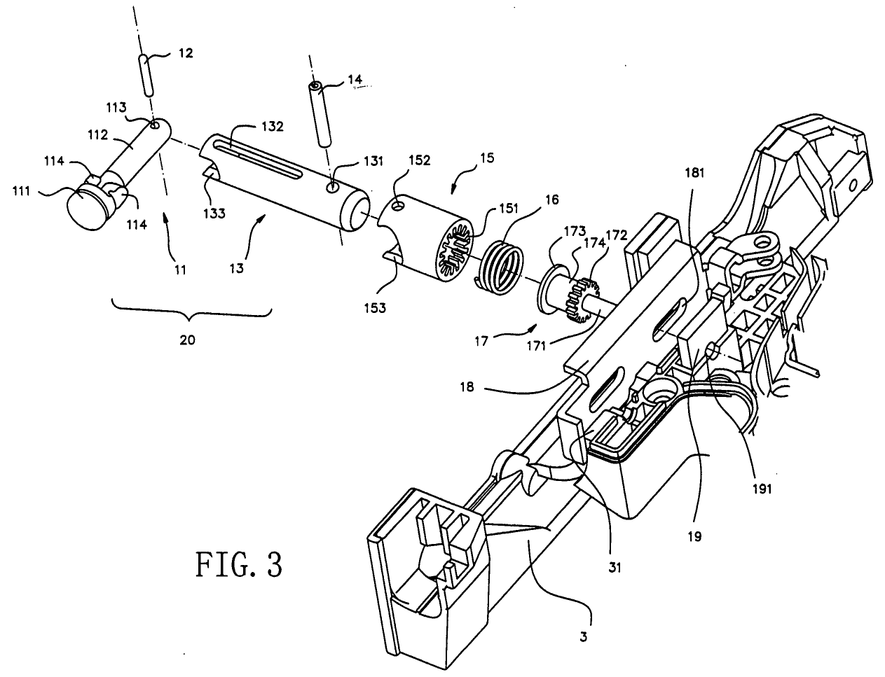

With reference to FIG. 3, the locking member 17 has a neck portion 174 with a shoulder 173 and a pinion 172 at its two ends respectively. A biasing member 16 (e.g., a coil compression spring) encircles the neck portion 174 of the locking member 17. The locking member 17 is positioned inside a cylindrically shaped turnable sleeve 15, which comprises an internal tooth ring 151 at its one end and a curved notch 153 at its other end. A pair of diametrically aligned holes 152 are adjacent the curved notch 153. In a first operating position, the internal tooth ring 151 engages with the pinion 172 of the locking member 17 by effect of the spring 16.

The foot plate adjusting device 10 further comprises a rotatable actuator assembly 20 including a cylindrical operating rod 13 and a handle 11. The operating rod 13 has an inner cavity, a diametrical through hole 131 at a first end, and a pair of diametrically symmetrical notches 133 at a second end. A pair of axial elongated through slots 132 are formed in the middle wall of the cylindrical operating rod 13. The handle 11 includes a head portion 111 and a cylindrical rod portion 112. One end of the cylindrical rod portion 112 is connected to the head 111 and a through hole 113 is formed at the other end of the rod portion 112. The diameter of the cylindrical rod 112 is less than the head portion 111. In addition to the above-mentioned components, the foot plate adjusting device 10 further includes two cylindrical pins 12 and 14, wherein the pin 14 is inserted through the hole 152 in the turnable sleeve 15 and the hole 131 in the operating rod 13 so as to connect one end of the operating rod 13 to the turnable sleeve 15 and to make it pivotal around the pin 14. Moreover, the notch 153 is positioned and dimensioned in such a manner that the operating rod 13 can be seated in the notch 153 thereby to pivot to a position perpendicular to the turnable sleeve 15.

In a similar fashion, the pin 12 extends through the slots 132 in the operating rod 13 and the hole 113 in the rod portion 112. In this manner, the rod portion 112 of the handle 11 is connected to the operating rod 13 and can be inserted into or drawn out of the cavity in the operating rod 13 by means of the pin 12 sliding along the slots 132. The head portion 111 of the handle 11 further has a pair of protrusions 114. When the handle 11 is fully inserted into the operating rod 13, the protrusions 114 can be laterally seated in the notches 133. When the handle 11 is drawn completely out of the operating rod 13, the handle 11 can be pivoted around the pin 12 to a position perpendicular to the operating rod 13 with the rod portion 112 being inserted into the notches 133.

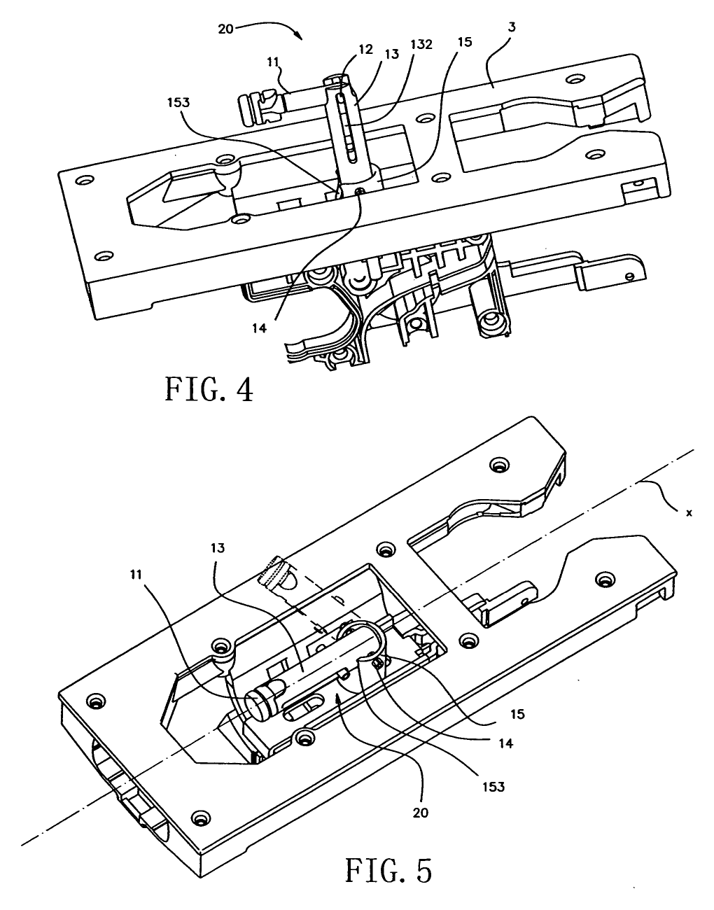

In a normal cutting condition of the jigsaw, the rotatable actuator assembly 20 and turnable sleeve 15 are in the positions as shown by the solid lines in FIG. 5 with the rotatable actuator assembly 20 lying, along the longitudinal direction of the foot plate 3, in the notch 153 of the turnable sleeve 15. When it is necessary to adjust the foot plate 3, the user may pull the operating rod 13 out of the notch 153 and turn it perpendicular to the foot plate 3 by pivoting the operating rod 13 about pin 14. After that, the handle 11 may be drawn out of the operating rod 13 and turned perpendicular to the operating rod 13, as shown in FIG. 4. In this configuration, the L-shaped rotatable actuator assembly 20 is operable to turn the turnable sleeve 15 via the pin 14. Because of the engagement between the internal tooth ring 151 of the turnable sleeve 15 and the pinion 172 of the locking member 17, the fastener 171 of the locking member 17 is thus turned together with the turnable sleeve 15. Accordingly, the foot plate 3 can be tightened or loosened.

After the foot plate 3 has been adjusted to a desired position via the mating of the curvilinear surface of the dome 31 and a portion of the housing 1, and the bolt 171 is retightened, the rotatable actuator assembly 20 may not exactly be in the position as shown by the solid lines in FIG. 5. Instead, the rotatable actuator assembly 20 may be is inclined at an angle to the longitudinal axis X, as shown by the dashed lines in FIG. 5. In this condition, the rotatable actuator assembly 20 extends out of the recess or spacing in the bottom of the foot plate 3 and makes it impossible to cut. To solve this problem, a user can pull the rotatable actuator assembly 20 (in a direction away from the foot plate 3) forcing the turnable sleeve 15 against the biasing member or spring 16. As the biasing member or spring 16 compresses, the internal tooth ring 151 and the pinion 172 will disengage from one another. Thus, the rotatable actuator assembly 20 and turnable sleeve 15 can be turned freely to have the notch 153 in a desirable direction, that is, parallel to the axis designated X in FIG. 5. The rotatable actuator assembly 20 can then be lowered down and pressed in the notch 153. At this time, the internal tooth ring 151 of the turnable sleeve 15 will re-engage with the pinion 172 of the locking member 17 under the biasing force of the spring 16. The rotatable actuator assembly 20 will lie along the longitudinal axis X (as shown by the solid lines in FIG. 5), and be positioned within the recess or space in the foot plate 3. In this folded configuration, the rotatable actuator assembly 20 is “out of the way” and the jigsaw may be used to cut a desired object.

While the invention has been described and illustrated in a preferred embodiment, the description and illustration is exemplary and explanatory but not intended to limit the invention to the extent disclosed herein. It is obvious that those who are skilled in this field may make changes and modifications without departing from the spirit and scope of the invention. Therefore, all changes and modifications based on the innovation of the invention all fall in the invention's scope claimed in the appended claims.

What is claimed is:

1. A device for adjusting a foot plate of a jigsaw, comprising:
a locking member having a first and second end;
a rotatable sleeve connected to the first end of the locking member;
a fastener connected to the second end of the locking member for fastening the foot plate to a housing to the jigsaw;
a rotatable actuator assembly pivotally connected to the rotatable sleeve;
wherein the rotatable sleeve and the locking member each have an engagement portion that are engageable with each other, and a biasing member is provided between the rotatable sleeve and the locking member for biasing the engagement portions to an engagement or disengagement position.

2. The device of claim 1, wherein said engagement portions comprise an internal tooth ring and a pinion provided on the rotatable sleeve and the locking member, respectively.

3. The device of claim 1, wherein said rotatable sleeve comprises a notch, which allows the rotatable actuator assembly to be rotated to a position parallel to the foot plate.

4. The device of claim 1, wherein the locking member further includes a neck portion and a shoulder, the biasing member being encircled on the neck portion and restrained by the shoulder.

5. The device of claim 1, wherein the rotatable actuator assembly comprises an operating rod and a handle that is retractable within and pivotal about the operating rod.

6. The device of claim 5, wherein the operating rod is connected to the rotatable sleeve at its one end and has a notch at its other end, the notch being positioned and dimensioned in such a manner that the handle can be laterally seated in the notch.

7. The device of claim 6, wherein the operating rod further comprises a pair of longitudinal and diametrically symmetrical through slots and one end of the handle is slidably connected to the slots via a second pin.

8. A device for adjusting a foot plate of a jigsaw, comprising:
a locking member having an engagement portion, a shoulder and a fastener connected therewith for fastening the foot plate to a housing of the jigsaw;
a rotatable sleeve having an engagement portion that is engageable with the engagement portion of the locking member;
a rotatable actuator assembly connected to the rotatable sleeve;
a biasing member provided between the rotating sleeve and the locking member;
the rotatable actuator assembly having a first operating position wherein the rotatable sleeve and the locking member are engaged and rotation of the rotatable actuator assembly causes the rotation of the fastener and a second operating position wherein the rotatable sleeve and the locking member are disengaged and rotation of the rotatable actuator assembly causes the rotatable sleeve to rotate about the locking member.

9. The device of claim 8, wherein the rotatable actuator assembly comprises an operating rod and a handle which can be slidably inserted into cavity in the operating rod and can be pivoted about one end of the operating rod.

10. The device of claim 9, wherein the operating rod is connected to the rotatable sleeve at a first end and has a notch at a second end of the rotatable sleeve, the notch being positioned and dimensioned in such a manner that the handle can be laterally seated in the notch.

11. The device of claim 10, wherein the operating rod further comprises a pair of longitudinal and diametrically symmetrical through slots and one end of the handle is slidably connected to the slots in the operating rod.

12. A combination of a base plate and a cutting tool, the base plate being connected to the cutting tool via a fastening member, the combination comprising:
a fastening plate connected to the cutting tool for receiving the fastening member; and
a rotatable actuator assembly connected to the fastening member via a biasing member which has a first position wherein the rotatable actuator assembly is rotatably engaged with the fastening member and a second position wherein the rotatable actuator assembly is rotatably disengaged from the fastening member.
